(19) United States
(12) Patent Application Publication
(10) Pub. No.: US 2005/0001798 A1
(43) Pub. Date: Jan. 6, 2005

(54) Liquid crystal drive method, liquid crystal display system and liquid crystal drive control device

(75) Inventors: Shinobu Nohtomi, Tokyo (JP); Shigeru Ota, Koganei (JP); Shinya Suzuki, Kodaira (JP); Yoshitaka Iwasaki, Tachikawa (JP); Masahito Fujihira, Mobara (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/822,730

(22) Filed: Apr. 13, 2004

(30) Foreign Application Priority Data
Jun. 5, 2003 (JP) 2003-160538

(51) Int. Cl. G09G 3/36

(52) U.S. Cl. 345/87

(57) ABSTRACT

There are provided a liquid crystal drive method, a liquid crystal display system and a liquid crystal drive control device, which can realize low power consumption at an alternating current drive of a liquid crystal panel. A common voltage given to a common electrode of a liquid crystal is switched between a positive phase and a negative phase. Display data is converted in such a manner that first display data and second display data selecting two of a plurality of gradation voltages in which magnitudes of potential differences in the pixel electrodes in the positive phase and the negative phase with reference to the common voltage corresponding to display data in a display memory are the same are in the same bit pattern except for one specified bit. For example, bit allocation of positive and negative gradation display data is made in such a manner that low-order bits other than the highest order bit are symmetric up and down in binary with respect to the middle.

### CROSS-REFERENCE TO RELATED APPLICATION

The present application claims priority from Japanese patent application JP 2003-160538 filed on Jun. 5, 2003, the content of which is hereby incorporated by reference into this application.

### BACKGROUND OF THE INVENTION

The present invention relates to a liquid crystal drive method, a liquid crystal display system and a liquid crystal drive control device. The present invention relates mainly to a technique effective to be used for performing gradation display using a TFT (thin film transistor) liquid crystal display panel.

As a liquid crystal drive voltage switch method for the alternating current drive of a liquid crystal panel, the present inventors have studied a dynamic switch method and a control bit switch method prior to the present invention. FIG. 11 shows state changes at positive-negative switch in the dynamic switch method. In the dynamic switch method, display data set to each terminal cannot be changed due to positive-negative switch. A gradation generation circuit part for supplying a voltage to signal lines of a liquid crystal display panel is switched to a positive-negative level. Since display data cannot be changed due to positive-negative switch, the same selector switch is brought to the on state. In the negative phase, as indicated by the dotted lines in the drawing, voltages are switched so as to be symmetric up and down with respect to the midpoint voltage.

FIGS. 12 and 13 show state changes at positive-negative switch in the control bit switch method. In the control bit switch method, data set to each terminal is switched corresponding to positive and negative gradation voltage for the positive and negative phases. Display data having the highest order potential in the positive phase is switched to have the lowest order potential in the negative phase. An exclusive logic circuit outputs the display data as it is as logic 0 in the positive phase by a positive-negative switch signal, and inverts all or most bits of the display data as logic 1 in the negative phase. FIG. 14 shows data and selective levels of 32 gradations of 0 to 31 corresponding to the control bit switch method.

### SUMMARY OF THE INVENTION

In the dynamic switch method, since all outputs of an amplifier generating a liquid crystal voltage are switched without fail, an electric current is consumed. In addition, one switch MOSFET changes voltages of the selected signal lines up and down by positive-negative switch. The output impedance of the selector switch MOSFET must be lowered corresponding to all the gradation voltages. The size of the MOSFET is formed to be large in consideration of the worst case, thereby increasing the chip area. In the control bit switch method, gradation voltages in a positive phase and a negative phase exist for each of adjacent scanning lines. Basically, display data of adjacent pixels is never or hardly changed so that its hamming distance is small. All or most control signals are changed for each positive-negative switch. The level shifter circuits boosting a logic control voltage to a display control voltage are operated to increase the current consumption.

An object of the present invention is to provide a liquid crystal drive method, a liquid crystal display system and a liquid crystal drive control device, which can realize low power consumption at an alternating current drive of a liquid crystal panel. The above and other objects and novel features of the present invention will be apparent from the description of this specification and the accompanying drawings.

The representative inventions disclosed in the present invention will be briefly described as follows. A common voltage given to a common electrode of a liquid crystal is switched between a positive phase and a negative phase. Display data in display memory is converted in such a manner that first display data and second display data selecting two of a plurality of gradation voltages which are the same in the positive phase and the negative phase with reference to the common voltage corresponding to the display data in the display memory of FIG. 6 are in the same bit pattern except for one specified bit.

The hamming distance between the first display data and the second display data is 1. For example, in display data conversion, bit allocation of positive and negative gradation display data is made in such a manner that low-order bits other than the highest order bit are symmetric up and down in binary with respect to the middle. A bit conversion circuit for performing the display data conversion is provided in a liquid crystal drive control device. The circuit inverts all or most bits for each switch between positive the phase and the negative phase. All or most logics and level shifter circuits shifting the voltage level from a logic voltage to a liquid crystal voltage are operated.

In the present invention, as shown in FIG. 6, only one specified bit is changed at switch between the positive phase and the negative phase corresponding to display data in a display memory. The number of logics constructing decoders operated and level shifter circuits shifting the voltage level from a logic voltage to a liquid crystal voltage is about 1/gradation bits (1 divided by gradation bits) as compared with the prior art.

### BRIEF DESCRIPTION OF THE DRAWINGS

FIG. 1 is a block diagram of the main part of an embodiment of a liquid crystal display device according to the present invention;

FIG. 2 is a block diagram showing an embodiment of an SEG driver according to the present invention corresponding to the positive phase;

FIG. 3 is a block diagram showing an embodiment of the SEG driver according to the present invention corresponding to the negative phase;

FIG. 4 is a schematic circuit diagram showing an embodiment of the SEG driver according to the present invention corresponding to the positive phase;

FIG. 5 is a schematic circuit diagram showing an embodiment of the SEG driver according to the present invention corresponding to the negative phase;

FIG. 6 is a gradation display data relation diagram showing a conversion example of an embodiment of display data according to the present invention;

FIG. 7 is a waveform diagram showing an example of voltages added to a liquid crystal according to the present invention;

FIG. 8 is a voltage waveform diagram of assistance in explaining the relation between the gradation voltage and the common voltage used for the present invention;

FIG. 9 is a circuit diagram showing an embodiment of a level shift circuit used for the present invention;

FIG. 10 is a circuit diagram showing an embodiment of a booster circuit of FIG. 1;

FIG. 11 is an alternating current drive explanatory view of liquid crystal voltages by a dynamic switch method which has been studied prior to the present invention;

FIG. 12 is an alternating current drive explanatory view of a liquid crystal voltage in the positive phase by a control bit switch method which has been studied prior to the present invention;

FIG. 13 is an alternating current drive explanatory view of a liquid crystal voltage in the negative phase by the control bit switch method which has been studied prior to the present invention;

FIG. 14 is a gradation display data relation diagram by the control bit switch method which has been studied prior to the present invention;

FIG. 15 is a block diagram showing an embodiment of an alternating current drive circuit of a liquid crystal voltage by the control bit switch method according to the present invention; and

FIG. 16 is a block diagram showing an embodiment of a schematic diagram of a liquid crystal pixel in a liquid crystal panel according to the present invention.

### DESCRIPTION OF THE PREFERRED EMBODIMENTS

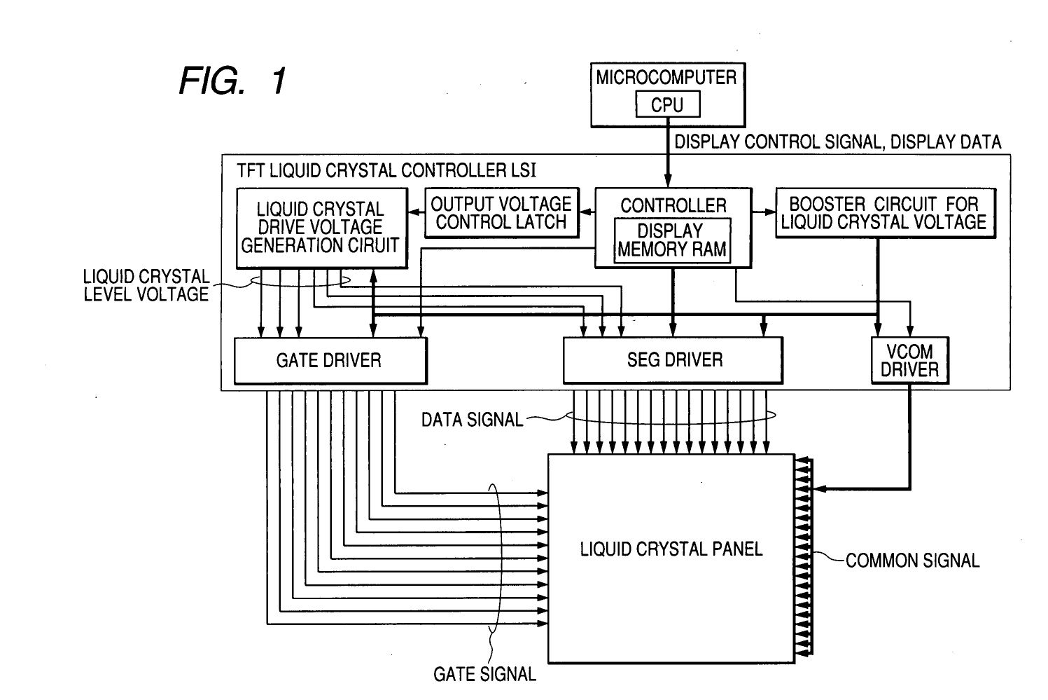

FIG. 1 shows a block diagram of the main part of an embodiment of a liquid crystal display device and a liquid crystal display system according to the present invention. Not being particularly limited, a TFT liquid crystal controller LSI (hereinafter, also called a liquid crystal driver and an LCD driver) according to the present invention is manufactured over one semiconductor substrate using the known CMOS technique. The liquid crystal display device of this embodiment has a TFT liquid crystal controller LSI receiving a display control signal including display data generated by a microcomputer (microprocessing unit such as a microprocessor), not shown, and a liquid crystal panel.

Not being particularly limited, the TFT liquid crystal controller LSI is constructed by one semiconductor integrated circuit device and has a liquid crystal drive voltage generation circuit for supplying a voltage (gradation voltage) used for driving the liquid crystal panel; and as drivers for driving the liquid crystal panel based on the liquid crystal drive voltage, a SEG (segment) driver supplying a gradation voltage (data signal) to a signal line of the liquid crystal panel, a VCOM driver supplying a common voltage to a common electrode opposite the pixel electrode, and a GATE (gate) driver supplying a gate signal to a scanning line coupled to the gate of the TFT transistor of the liquid crystal panel. The signal line is coupled via the TFT transistor to the pixel electrode.

The TFT liquid crystal controller LSI has a controller for controlling the respective operations of the SEG (segment) driver, VCOM driver, GATE (gate) driver and liquid crystal drive voltage generation circuit, an output voltage control latch, and a booster circuit for liquid crystal voltage boosting a low operation voltage of the controller to supply the boosted high voltage to the respective drivers. The controller of the liquid crystal controller LSI has a display memory RAM as an incorporated memory storing display data.

Software executed by a central processing unit (CPU) in the microcomputer writes display data to be displayed on the liquid crystal panel to the display memory RAM in the liquid crystal controller. The display data written to the display memory RAM by the CPU has R (red) data, G (green) data and B (blue) data to each pixel when the liquid crystal panel is intended for color display. Not being particularly limited, each of the R, G and B data is expressed as gradation data of 5 bits. Not being particularly limited, the value of each of the gradation data is defined to be incremented by 1 in binary from the lowest gradation (gradation 0) 00000 to the highest gradation (gradation 31) 11111.

Bit order to allocation of gradation data are regarded to be defined by software executed by the CPU. Software executed by the CPU can be changed, bit order to allocation of gradation data can be changed by the software, and the gradation voltage selection operation at the change from the positive to negative phase or the change from the negative to positive phase at alternating current drive can be performed by a low power consumption.

To perform these, the change of the existing software resources, development of new software and the change of the data form of the entire liquid crystal display system are necessary. The system development period can be longer, and the system development cost can be increased. In a technique whose product cycle is short, the longer system development period and the increased system development cost are considered to be a critical loss.

In the case of system change so as to use the existing liquid crystal display system, software and data form as they are and to replace only the liquid crystal controller, the liquid crystal display system can impose a compatible problem. When changing gradation data allocation by the software, the gradation voltage selection operation at the change from the positive phase to the negative phase or the change from the negative phase to the positive phase at alternating current drive may be performed by a low power consumption. In the liquid crystal display system using the existing liquid crystal controller LSI, the gradation data allocation is changed. A color to be displayed cannot be displayed in the color intended for the liquid crystal panel.

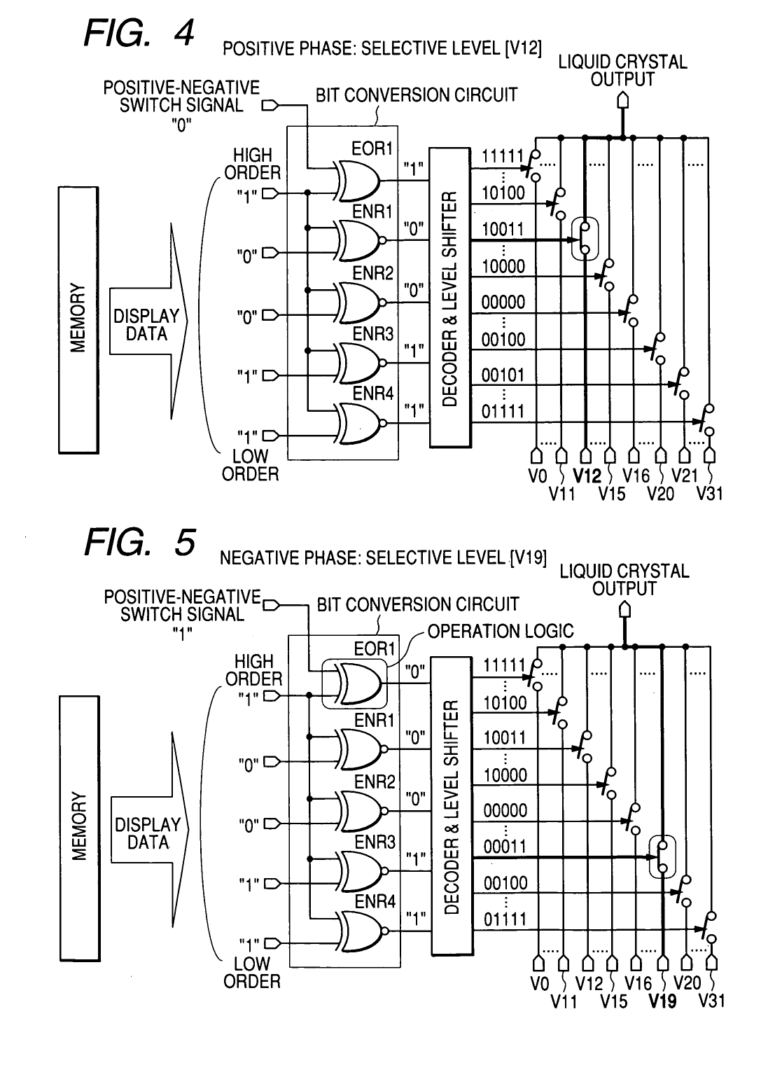

Without changing the software of the CPU, in other words, in order that a color to be displayed can be displayed in the color intended for the liquid crystal panel, the gradation data allocation is the same as the prior art to maintain compatibility. The gradation voltage selection operation at the change from the positive phase to the negative phase or the change from the negative phase to the positive phase at alternating current drive can be performed by a low power consumption. To perform these, in the present invention, a bit conversion circuit as shown in FIGS. 4 and 5 for performing bit order conversion of gradation data outputted from the display memory RAM is provided between the output of the display memory RAM and the gradation selector.

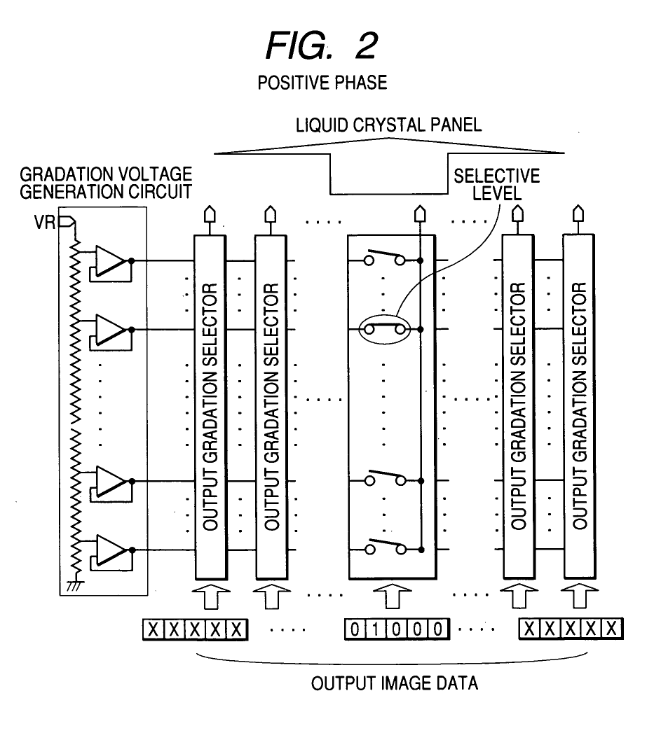

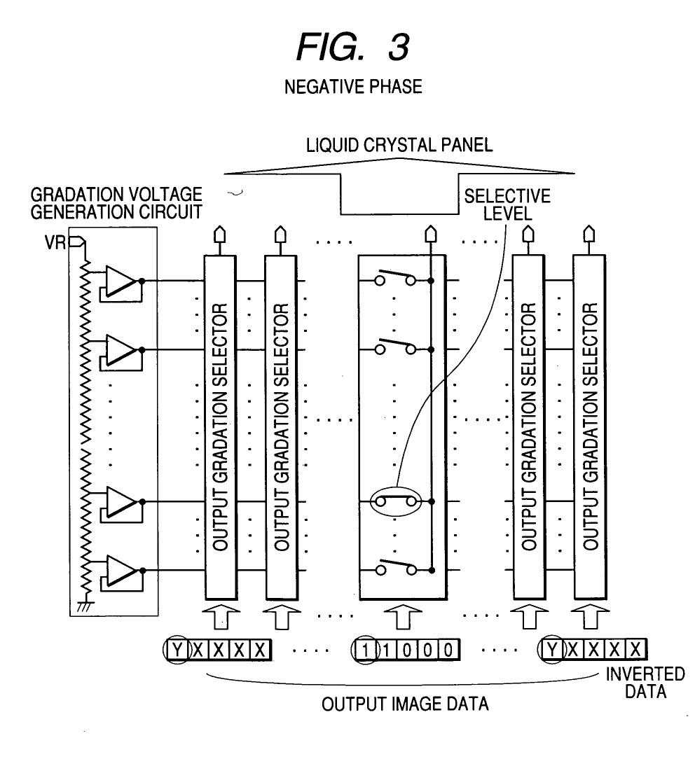

FIGS. 2 and 3 show block diagrams of an embodiment of the SEG driver according to the present invention, in which FIG. 2 corresponds to the positive phase (first phase), and FIG. 3 corresponds to the negative phase (second phase). In FIGS. 2 and 3, a gradation voltage generation circuit divides a voltage VR for generating a gradation voltage formed by the booster circuit by a serial resistor circuit. When performing 32-gradation display, 32 gradation voltages V0 to V31 corresponding to the respective gradations 0 to 31 are formed. The gradation voltages are shared and supplied to a plurality of output gradation selectors provided corresponding respectively to a plurality of signal lines of the liquid crystal panel.

There are two liquid crystal alternating current drive methods including “line alternating current drive method” replacing the positive phase and the negative phase for each scanning line, and “frame alternating current drive method” replacing the positive phase and the negative phase once after drawing one screen. The frame alternating current drive method has contrast of pixels lower than that of the line alternating current drive method, resulting in deterioration of the image quality. In this point, the line alternating current drive method is superior. This embodiment employs the line alternating current drive method.

One of the gradation selectors representatively illustrated has switches selecting the plurality of gradation voltages. The switch at the selective level corresponding to output image data is brought to the on state to select one of the plurality of gradation voltages for outputting the gradation voltage supplied to the signal line of the liquid crystal panel from the shared couple node of the switch.

In this embodiment, in the positive phase and the negative phase, the bit conversion circuit as shown in FIGS. 4 and 5 makes only the highest order bit of output image data different. For the following reason, there are selected the gradation voltage selected in the positive phase and the gradation voltage selected in the negative phase with reference to a common voltage supplied to a common electrode of a liquid crystal so that when display data stored in the display RAM in adjacent pixels in the direction vertical to the gate line direction are the same, the two gradation voltages are opposite in polarity and have the same magnitude in the pixel electrodes.

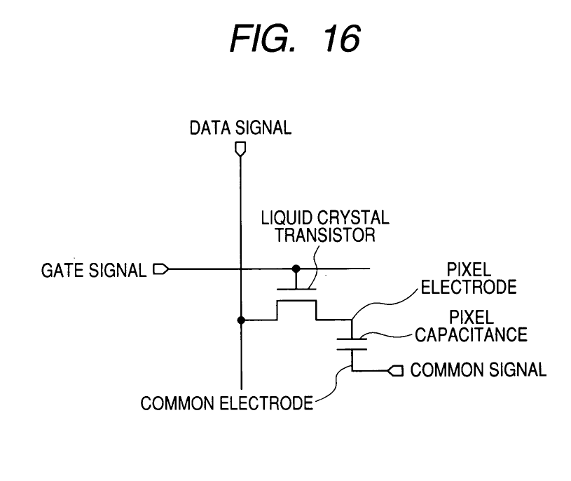

As shown in FIG. 16, a pixel electrode device has a transistor whose gate is coupled to the gate line and performing control of whether a gradation voltage is inputted to a capacitor having a pixel capacitance for applying a voltage to a liquid crystal pixel by a gate signal, and a capacitor of the pixel device holding a voltage for driving the liquid crystal panel based on a common voltage and gradation voltages. Since the drive voltage amplitude (e.g., −10 to 15V) of the gate line is large, getting electric charges in and out is performed in the load capacitance of the transistor at the drive of the gate. Since the load capacitance of the transistor is serial-coupled to the capacitor of the pixel device, the capacitor of the pixel device cannot ignore the electric charge variation of the capacitor of the pixel device due to getting electric charges in and out in the load capacitance of the transistor at the drive of the gate. In order that the voltage magnitudes in pixel polarity can be the same, the gradation voltage selected in the positive phase and the gradation voltage selected in the negative phase are set in consideration of coupling drop (transfer voltage) due to voltage accumulated in the load capacitance of the MOS when the gate signal in the pixel device is off.

FIGS. 4 and 5 show schematic circuit diagrams of an embodiment of the SEG driver including the bit conversion circuit according to the present invention, in which FIG. 4 corresponds to the positive phase, and FIG. 5 corresponds to the negative phase. This embodiment corresponds to the case of performing 32-gradation display as above in which display data has 5 bits. Not being particularly limited, the display memory RAM for writing and reading display data is included in the TFT liquid crystal controller LSI of FIG. 1. The highest order bit of the display data read from the display memory RAM is supplied to exclusive logic circuit EOR 1 and the remaining 4 bits are supplied to exclusive logic circuits ENR 1 to 4. In FIGS. 4 and 5, it is assumed that in data outputted from the bit conversion circuit, the display data stored in the display RAM in adjacent pixels in the direction vertical to the gate line direction is the same. The display data inputted to the bit conversion circuit may be different.

Not being particularly limited, in the exclusive logic circuit EOR 1, a positive-negative switch signal is supplied to the other input thereof from the controller in synchronization with the switch between the positive phase and the negative phase, the highest order bit is outputted as it is when the positive-negative switch signal is logic 0 (“0”) as in the positive phase of FIG. 4, and the highest order bit is inverted and outputted when the positive-negative switch signal is logic 1 (“1”) as in the negative phase of FIG. 5. In the exclusive logic circuits ENR 1 to 4, the display data having the highest order bit is supplied to the other input thereof, as shown in FIGS. 4 and 5, the bits of the respective display data are outputted as they are when the signal of the highest order bit is logic 1 (“1”). Although not shown, the bits of the respective display data are inverted and outputted when the signal of the highest order bit is logic 0 (“0”).

The exclusive logic circuit EOR 1 corresponding to the highest order bit of the display data outputs logic 0 when two inputs are matched with each other at logic 0 (“0”) or logic 1 (“1”), and outputs logic 1 when two inputs are not matched with each other at logic 1 (“0”) and logic 0 (“1”). The exclusive logic circuits ENR 1 to 4 corresponding to the low-order 4 bits of the display data output logic 1 (“1”) when two inputs are matched with each other at logic 0 (“0”) or logic 1 (“1”), and output logic 0 when two inputs are not matched with each other at logic 1 (“0”) and logic 0 (“1”).

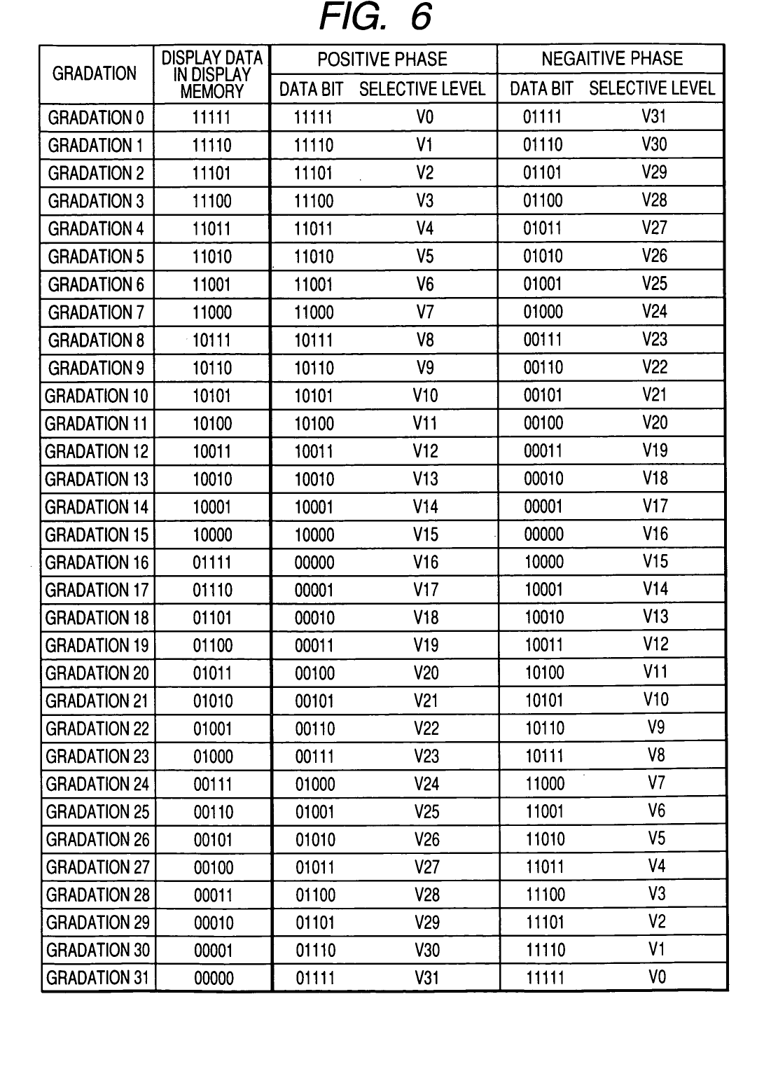

The bit conversion circuit as such display data conversion circuit is used so that display data in which the gradation 31 is the least binary value of 00000 and the gradation 0 is the largest binary value 11111 are converted, as shown in the diagram of the relation between gradations and display data of FIG. 6. In the positive phase, the low-order 4 bits are not inverted from the gradations 15 to 0 in which the highest order bit is logic 1. The binary values of 10000 to 11111 are sequentially changed corresponding to the original display data. The low-order 4 bits are inverted by the logic 0 of the highest order bit from the gradations 31 to 16 in which the highest order bit is logic 0. The binary values of 00000 to 01111 are sequentially changed and incremented from the gradations 16 to 31. The pattern of the low-order 4 bits of the display data converted from the gradations 0 to 15 and the gradations 16 to 31 of the 32 gradations is symmetric up and down.

In the negative phase, only the highest order bit is changed when the positive-negative switch signal is logic 1. In the positive phase and the negative phase, only the highest order bit is different and the remaining low-order 4 bits are in the same bit pattern in the positive phase and the negative phase. In the case of the same data in the positive phase and the negative phase, the hamming distance between the converted data is 1.

In FIG. 4, as shown in the drawing, when display data is “1”, “0”, “0”, “1” and “1”, the display data conversion circuit outputs, in the positive phase, the display data “1”, “0”, “0”, “1” and “1” as it is. The decoder forms a select signal selecting the gradation voltage V12 corresponding to 10011 from FIG. 6. The gradation voltage V12 is a liquid crystal output from the gradation selector.

In FIG. 5, when the display data is “1”, “0”, “0”, “1” and “1”, the positive-negative switch signal is logic 1 in the negative phase. The display data conversion circuit converts the display data to be “0”, “0”, “0”, “1” and “1” for output. The decoder forms a select signal selecting the gradation voltage V19 corresponding to 00011 from FIG. 6. The gradation voltage V19 is a liquid crystal output from the gradation selector. When the display data is “1”, “0”, “0”, “1” and “1”, the gradation voltages V12 and V19 are applied in the positive phase and the negative phase to the liquid crystal. The voltages opposite in polarity with reference to a common voltage and having the same magnitude in the pixel electrodes can be supplied.

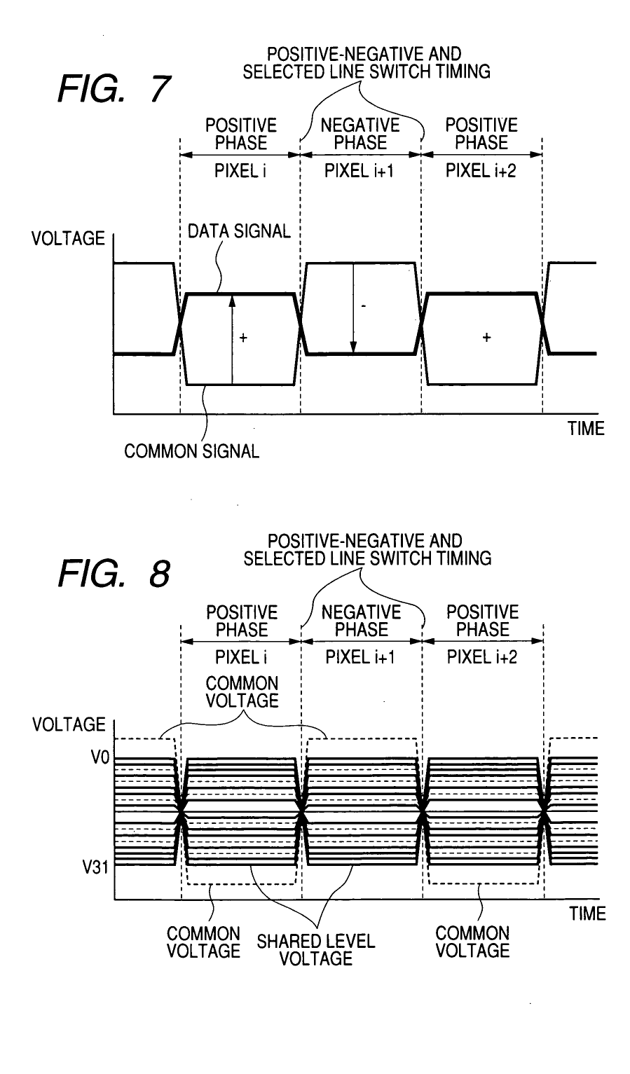

FIGS. 7 and 8 show voltage waveform diagrams added to the liquid crystal. In the positive phase, a common voltage is lower than the lowest voltage (the gradation 31) of 32 gradation voltages. The pixels i, i+1 and i+2 are adjacent pixels in the direction vertical to the gate line direction. When the gradation voltage V12 is selected from the gradation voltages V31 to V0 corresponding to the display data in the pixel i, a positive gradation voltage is applied to the liquid crystal pixel.

In the negative phase, a common voltage is higher than the highest voltage (the gradation 0) of 32 gradation voltages. When the gradation voltage V19 is selected from the gradation voltages V31 to V0 corresponding to the display data in the pixel i+1, a negative gradation voltage is applied to the liquid crystal pixel. The voltage difference between the gradation voltage V12 and the common voltage and the voltage difference between the gradation voltage V19 and the common voltage provide voltages opposite in polarity and having the same magnitude in the pixel electrodes, as described above. In FIGS. 7 and 8, it is assumed that in data outputted from the bit conversion circuit, display data stored in the display RAM in adjacent pixels in the direction vertical to the gate line direction is the same. The display data stored in the display RAM in adjacent pixels in the direction vertical to the gate line direction may be different.

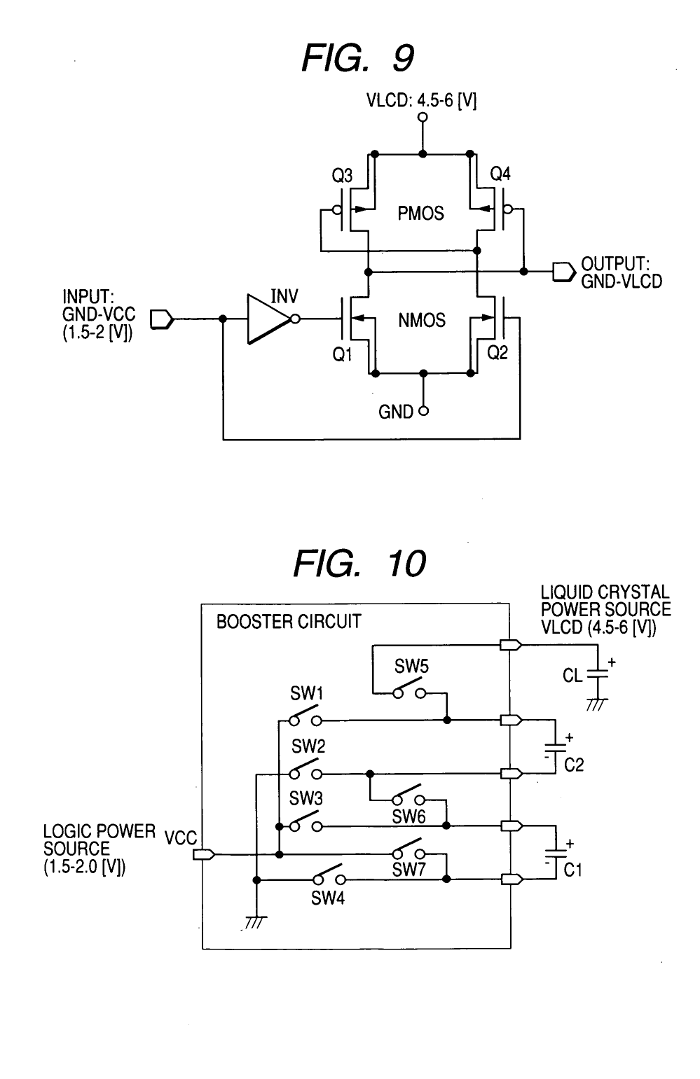

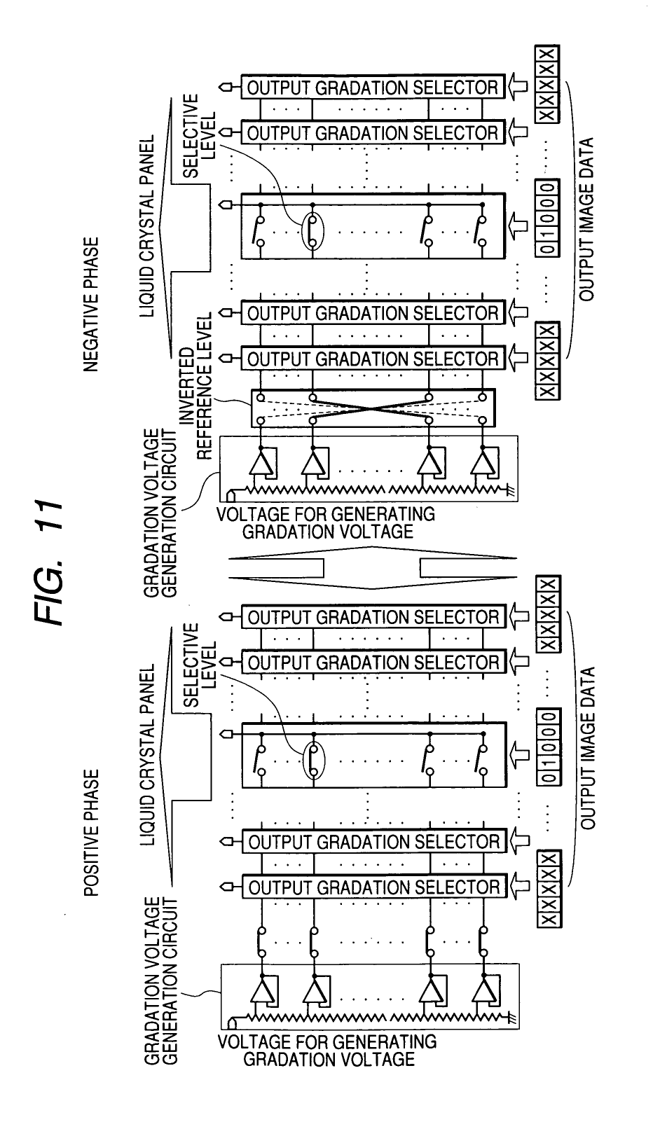

To output the gradation voltages V31 to V0, a voltage higher than a threshold voltage rather than the highest voltage V0 must be supplied to the gate of the MOSFET constructing a switch of FIGS. 4 and 5. The selective level of the select signal of the switch must be a relatively high voltage. To form such a select signal, a level shifter circuit as shown in FIG. 9 is used. The level shifter circuit level-shifts a logic signal of about 1.5 to 2V to 4.5 to 6V corresponding to the selective level.

The level shifter circuit has N-channel MOSFET Q1 and Q2 provided on the ground potential side of the circuit, P-channel MOSFET Q3 and Q4 provided on the high voltage VLCD side, and inverter circuit INV. The P-channel MOSFET Q3 and Q4 are in a latch form so that their gates and drains are cross-coupled. The drains of the N-channel MOSFET Q1 and Q2 are coupled respectively to the drains of the P-channel MOSFET Q3 and Q4. An input signal is inputted to the gate of the MOSFET Q2. An input signal inverted by the inverter circuit INV is supplied to the gate of the MOSFET Q1. An output signal is formed from the shared and coupled drain of the MOSFET Q1 and Q3.

When the input signal is at low level, the N-channel MOSFET Q2 is in the off state and the output signal of the inverter circuit INV is at high level. The N-channel MOSFET Q1 is thus in the on state. The on state of the MOSFET Q1 brings the P-channel MOSFET Q4 to the on state. The off state of the N-channel MOSFET Q2 brings the gate voltage of the P-channel MOSFET Q3 to the voltage VLCD. The P-channel MOSFET Q3 is thus in the off state. An output signal is at low level like the ground potential of the circuit corresponding to the on state of the MOSFET Q1.

When the input signal is changed from low level to high level, the N-channel MOSFET Q2 is in the on state so that the N-channel MOSFET Q1 is in the off state. The on state of the N-channel MOSFET Q2 draws out the gate potential of the P-channel MOSFET Q3 to the low level side to bring the MOSFET Q3 to the on state. The on state of the MOSFET Q3 charges up the gate voltage of the MOSFET Q4 to the voltage VLCD to bring the P-channel MOSFET Q4 to the off state. An output signal is at high level like the VLCD corresponding to the on state of the P-channel MOSFET Q3. A low-amplitude signal of 1.5 to 2.0 [V] is level-shifted to an output voltage of 4.5 to 6.0 [V].

FIG. 10 shows a circuit diagram of an embodiment of the booster circuit of FIG. 1. A clock (pulse signal) not shown, alternately switches switches SW 1, 2, 3 and 4 and SW 5, 6 and 7 between the on and off states. Capacitors C1, C2 for booster circuit are coupled in parallel with a boost reference power source of about 1.5 to 2V, e.g., operation voltage VCC of the logic circuit and are charged. They are switched to serial couple to charge up capacitance CL for output voltage by the boosted voltage for constructing a charge pump circuit forming the output voltage VLCD about three times the reference voltage VCC.

When the boosting clock is at high level, as shown in the drawing, the switches SW 1, 2, 3 and 4 are brought to the on state. When the SW 5, 6 and 7 are brought to the off state by the low level of the inverted boosting clock, the switches SW 1 and 3 supply the boost reference voltage VCC to the + electrodes of the capacitors C1 and C2. The switches SW 2 and 4 give the ground potential of the circuit to the − electrodes of the capacitors C1 and C2. The capacitors C1 and C2 are charged up to the boost reference voltage VCC.

When the boosting clock is changed from high level to low level, the switches SW 1, 2, 3 and 4 are switched to the off state and the switches SW 5, 6 and 7 are switched to the on state. The boost reference voltage VCC is given to the − electrode of the capacitor 1 by the on state of the switch SW 7. The capacitors C1 and C2 are coupled in a serial form by the on state of the switches SW 6 and 5. The triple boost voltage is outputted from the switch SW 5 to be transmitted to the capacitor CL. This is repeated in the same manner so that the output voltage VLCD is a boost voltage up to three times the boost reference voltage VCC. When requiring a higher voltage, it is boosted to be twice the boost voltage. Alternatively, when requiring a negative voltage below the ground potential of the circuit, avoltage in negative polarity can be formed from the triple boost voltage.

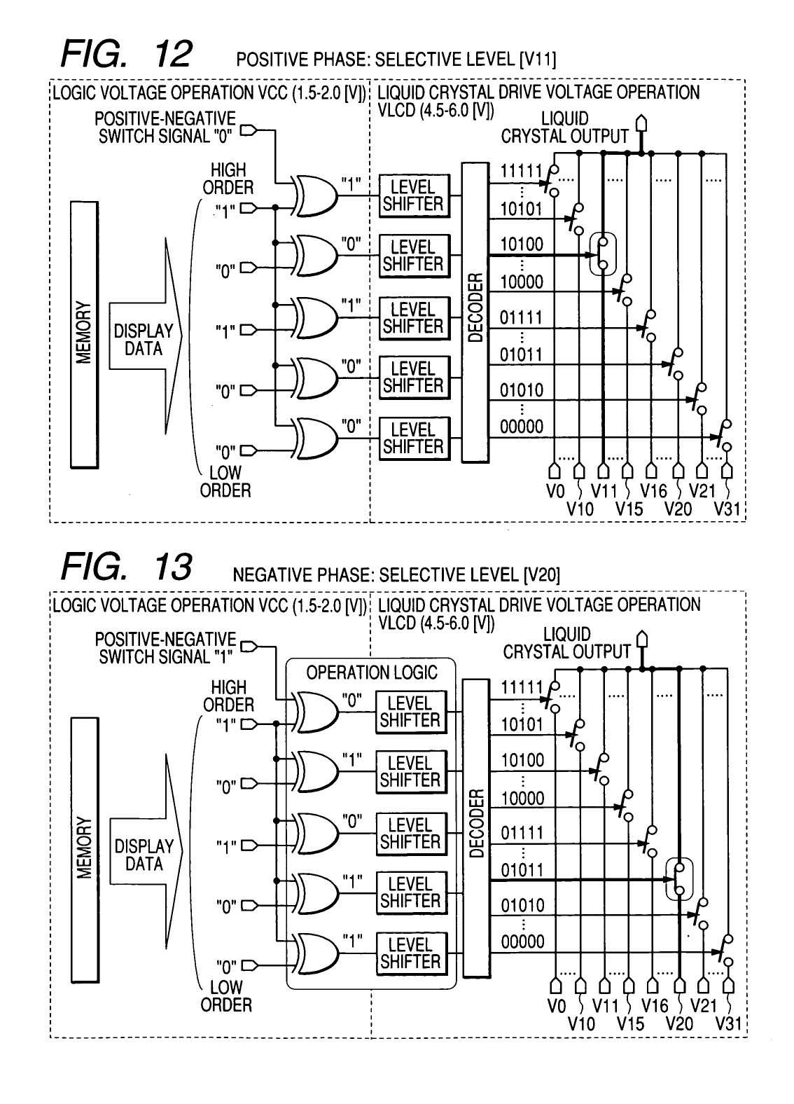

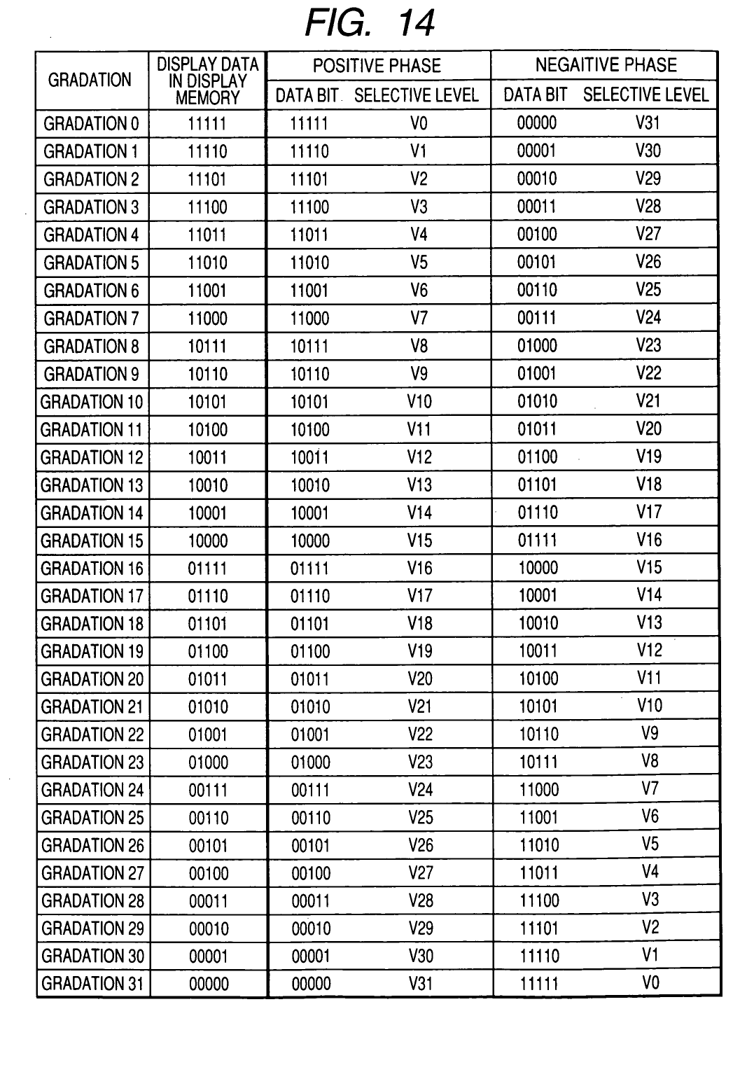

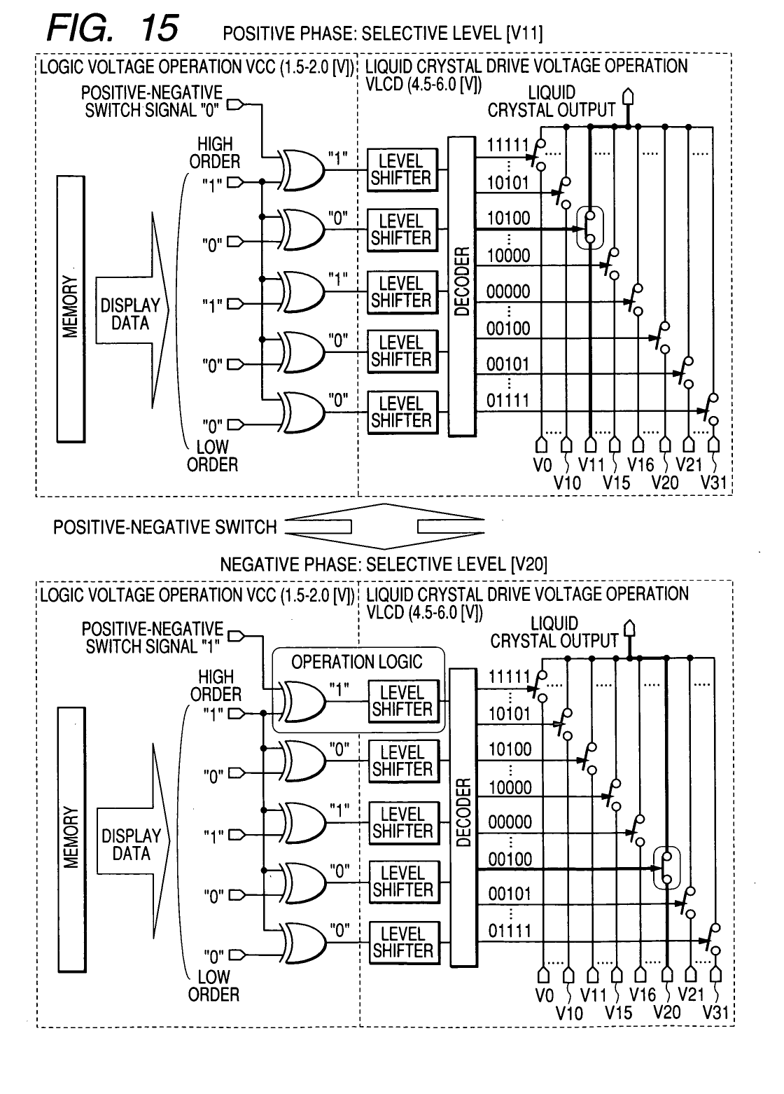

At the positive-negative switch of the liquid crystal output as shown in FIGS. 12 and 13, all or most logics and level shifter circuits shifting the voltage level from a logic voltage to a liquid crystal voltage are operated to all the bits. In this embodiment, as shown in FIG. 15, only the highest order bit is changed. The number of logics constructing decoders operated and level shifter circuits shifting the voltage level from a logic voltage to a liquid crystal voltage is 1/gradation bits (1 divided by gradation bits) as compared with the construction of FIGS. 12 and 13 when the gradation data of adjacent pixels are the same.

The liquid crystal voltage VLCD used in the level shifter circuit is a voltage generated by boosting the logic voltage VCC by the booster circuit. As the number of operation circuits is smaller, the power consumption of the entire chip can be lowered by a boost multiplying factor of the logic voltage. The present invention can reduce the amount of change in display data in the positive phase and the negative phase at alternating current drive. As the display frequency and the number of outputs are increased, the power consumption can be lowered. The display data bit allocation method according to the present invention can be applied regardless of the number of gradation bits. The effect can be increased as the number of gradation bits is increased.

For example, the example of the LSI is such that the number of signal lines of the liquid crystal panel is 720 with display data of 5 bits corresponding to the 32-gradation display. In the construction of FIGS. 12 and 13, signals for nearly 720×5=3600 circuits are changed at the switch between the positive phase and the negative phase. In the present invention, signals for about 720×1=720 circuits are changed at the switch between the positive phase and the negative phase so that the power consumption can be significantly lowered to 1/5. The CMOS circuit performs charge/discharge of the load capacitance by the change of signals to produce a consumed current. The reduction of the number of operation circuits can significantly lower the power consumption.

When the decoder circuit decodes the level-shifted display data, the number of operations of the level shifter circuit flowing a relatively large consumed current is tremendous as described above. A construction forming an operation voltage by the charge pump circuit significantly increases the consumed current in the charge pump circuit itself to make the power consumption larger. The present invention is applied to significantly reduce an electric current consumed by the circuit operations to about 1/gradation bits (1 divided by gradation bits).

The above-described construction decoding level-shifted display data for output requires five level shifter circuits per gradation selector. The construction level-shifting the output of the decoder circuit requires 32 level shifter circuits corresponding to 32 gradations. The level shifter circuit must form the size of the MOSFET used for performing the level shift operation fast to be large, requiring an occupation area about 10 to 15 times the gate circuit constructing the decoder. The above-described construction supplying level-shifted display data to the decoder is advantageous to reduce the occupation area.

The present invention which has been made by the present inventors is specifically described above based on the embodiments. The present invention is not limited to the embodiments and various modifications can be made in the scope without departing from its purpose. For example, the data conversion construction changing only one specified bit of display data in the positive phase and the negative phase may use the highest order bit as in the embodiments, and so on.

In FIG. 6, display data in binary can be converted most easily. In the positive phase and the negative phase in the drawing, when the highest order bit is replaced with any one of low-order 4 bits to decode the respective bit patterns by the decoder, the same effect can be obtained. The data conversion circuit may include a circuit performing such bit replacement. The present invention can be widely used as the liquid crystal drive method and the liquid crystal display device used for a portable phone and a portable small electronic terminal operated by a battery. The present invention is also effective for the positive-negative switch method for each scanning line selection. When it is applied to the frame alternating current drive method, no problems occur since display data is not changed at all. The application of the present invention can optimally apply the line alternating current drive method and the frame alternating current drive method by a simple construction to lower the power consumption in the line alternating current drive method.

The effects obtained by the representative inventions disclosed in the present invention will be briefly described as follows. A common voltage given to a common electrode of a liquid crystal is switched between the positive phase and the negative phase corresponding to display data in display memory. Display data is converted in such a manner that first display data and second display data selecting two of a plurality of gradation voltages in which the magnitudes of the potential differences in the pixel electrodes in the positive phase and the negative phase with reference to the common voltage are the same are in the same bit pattern except for one specified bit. For example, bit allocation of positive and negative gradation display data is made in such a manner that low-order bits other than the highest order bit are symmetric up and down with respect to the middle and that the highest order bit is an up-and-down allocation bit.

Without changing the existing software and the existing gradation data allocation, the bit conversion circuit of the present invention is provided in the LCD driver. It is possible to provide the LCD driver which can secure compatibility and can perform the gradation voltage selector operation at the change from the positive phase to the negative phase or the change from the negative phase to the positive phase at alternating current drive by a low power consumption.

When using the LCD driver of the present invention in the case of system change so as to use the existing liquid crystal display system and software as they are and to replace only the LCD driver, the gradation voltage selector operation at the change from the positive phase to the negative phase or the change from the negative phase to the positive phase at alternating current drive can be performed by a low power consumption. In addition, the bit order and allocation of the respective gradation data of RGB corresponding to each pixel stored in the incorporated memory of the LCD driver by the CPU are the same as the prior art. It is thus possible to provide the liquid crystal display system which can display a color to be displayed in the color intended for the liquid crystal panel.

1. A liquid crystal drive method comprising a circuit having a plurality of gradation voltages to be given to a pixel electrode of a liquid crystal and a common voltage given to a common electrode of the liquid crystal in which said common voltage is switched between a positive phase and a negative phase, a first voltage is applied as said gradation voltage in the positive phase of said common voltage, a second voltage is applied as said gradation voltage in the negative phase of said common voltage, said first voltage and said second voltage are opposite in polarity with reference to a voltage of the common electrode, said first voltage is selected from first display data, and said second voltage is selected from second display data,
wherein said first display data and said second display data are obtained by converting display data from outside, and when said first and second display data are the same, said first display data and said second display data are in the same bit pattern except for one specified bit.

2. The liquid crystal drive method according to claim 1, wherein said one specified bit is the highest order bit.

3. The liquid crystal drive method according to claim 2,
wherein when a positive-negative switch signal of said positive phase and negative phase is at a level corresponding to logic 0, the highest order bits of said first display data and second display data are allocated as they are, respectively, and when said positive-negative switch signal is at a level corresponding to logic 1, the highest order bits of said first display data and said second display data are inverted and allocated, respectively,
wherein when said highest order bits are at a level corresponding to logic 1, data of the second order and lower bits of said first display data and second display data are allocated as they are, and when said highest order bits are at a level corresponding to logic 0, the second order and lower bits of said first display data and second display data are inverted and allocated.

4. The liquid crystal drive method according to claim 1,
wherein said circuit outputs display data from an incorporated memory writing and reading said display data to be displayed on a liquid crystal panel, and
wherein said display data is converted by a display data conversion circuit to said first display data and second display data, respectively, by control of the positive-negative switch signal.

5. The liquid crystal drive method according to claim 1, wherein said display data is given by a microprocessing unit for generating said display data.

6. A liquid crystal display system comprising:
a liquid crystal display panel having a signal line supplying a gradation voltage to a pixel electrode, a scanning line selecting the pixel electrode, and a common electrode opposite said pixel electrode;
a liquid crystal drive voltage generation circuit generating a plurality of gradation voltages for gradation display;
a segment driver including an output gradation selector selecting any one of said plurality of gradation voltages according to display image data to output the gradation voltage to the signal line of said liquid crystal display panel;
a gate driver outputting a select signal sequentially selecting the scanning line of said liquid crystal display panel according to a display timing signal; and
a common electrode drive circuit switching a common voltage given to the common electrode of said liquid crystal display panel by a positive-negative switch signal corresponding to a positive phase and a negative phase,
wherein said common electrode drive circuit switches said common voltage between said positive phase and negative phase,
wherein said output gradation selector receives, as an input, first display data in the positive phase of said common voltage, outputs a signal selecting a first voltage as said gradation voltage corresponding to said first display data to said liquid crystal drive voltage generation circuit, receives, as an input, second display data in the negative phase of said common voltage, and outputs a signal selecting a second voltage as said gradation voltage corresponding to said second display data to said liquid crystal drive voltage generation circuit,
wherein said first display data and said second display data are obtained by converting display data from outside, and there is provided a display data conversion circuit that converts for output, to said first display data and said second display data, display data to be displayed on said liquid crystal display panel so that other bits are the same except for one specified bit when said first and second display data are the same.

7. The liquid crystal display system according to claim 6,
wherein said one specified bit is the highest order bit, and
wherein said display data conversion circuit outputs the highest order bits of display data as they are when a positive-negative switch signal of said positive phase and negative phase is at a level corresponding to logic 0, inverts and outputs the highest order bits of said display data when said positive-negative switch signal is at a level corresponding to logic 1, thereby forming the highest order bits of said first display data and second display data, outputs data of the second order and lower bits of said first display data and second display data as they are when said highest order bits are at a level corresponding to logic 1, and outputs inverted data of the second order and lower bits of said first display data and second display data when said highest order bits are at a level corresponding to logic 0.

8. The liquid crystal display system according to claim 7, wherein said first display data and second display data are transmitted to a decoder circuit having a low voltage amplitude corresponding to a logic circuit, an output signal of the decoder circuit is transmitted to a level shifter circuit shifting a signal of said low voltage amplitude to a signal of a high voltage amplitude, and an output signal of the level shifter circuit is decoded to form a select signal selecting said gradation voltage.

9. The liquid crystal display system according to claim 8, wherein an operation voltage of said level shifter circuit is a boost voltage formed by a charge pump circuit.

10. The liquid crystal display system according to claim 6, wherein said segment driver has an incorporated memory writing and reading said display data to be displayed on said liquid crystal panel, and
wherein said display data conversion circuit converts said display data outputted from said incorporated memory to said first display data and second display data, respectively, by a positive-negative switch signal.

11. The liquid crystal display system according to claim 6, wherein said liquid crystal display system has a microprocessing unit for generating said display data.

12. A liquid crystal drive control device comprising:
a liquid crystal drive voltage generation circuit generating a plurality of gradation voltages for gradation display;
a segment driver including an output gradation selector selecting any one of said plurality of gradation voltages according to display image data to output the gradation voltage to a signal line of said liquid crystal display panel;
a gate driver outputting a select signal sequentially selecting a scanning line of said liquid crystal display panel according to a display timing signal; and
a common electrode drive circuit switching a common voltage given to a common electrode of said liquid crystal display panel by a positive-negative switch signal corresponding to a positive phase and a negative phase and to be given to a pixel electrode of a liquid crystal based on a voltage given to said common electrode,
wherein said common electrode drive circuit switches said common voltage between said positive phase and negative phase,
wherein said output gradation selector receives, as an input, first display data in the positive phase of said common voltage, outputs a signal selecting a first voltage as said gradation voltage corresponding to said first display data to said liquid crystal drive voltage generation circuit, receives, as an input, second display data in the negative phase of said common voltage, and outputs a signal selecting a second voltage as said gradation voltage corresponding to said second display data to said liquid crystal drive voltage generation circuit, and
wherein said first display data and said second display data are obtained by converting display data from outside, and there is provided a display data conversion circuit that converts for output, to said first display data and said second display data, said display data to be displayed on said liquid crystal display panel so that other bits are the same except for one specified bit when said display data are the same.

13. The liquid crystal drive control device according to claim 12,
wherein said one specified bit is the highest order bit, and
wherein said display data conversion circuit outputs the highest order bits of display data as they are when a positive-negative switch signal of said positive phase and negative phase is at a level corresponding to logic 0, inverts and outputs the highest order bits of said display data when said positive-negative switch signal is at a level corresponding to logic 1, thereby forming the highest order bits of said first display data and second display data, outputs data of the second order and lower bits of said first display data and second display data as they are when said highest order bits are at a level corresponding to logic 1, and outputs inverted data of the second order and lower bits of said first display data and second display data when said highest order bits are at a level corresponding to logic 0.

14. The liquid crystal drive control device according to claim 13, wherein said first display data and second display data are transmitted to a decoder circuit having a low voltage amplitude corresponding to a logic circuit, an output signal of the decoder circuit is transmitted to a level shifter circuit shifting a signal of said low voltage amplitude to a signal of a high voltage amplitude, and an output signal of the level shifter circuit is decoded to form a select signal selecting said gradation voltage.

15. The liquid crystal drive control device according to claim 14, wherein an operation voltage of said level shifter circuit is a boost voltage formed by a charge pump circuit.

16. The liquid crystal drive control device according to claim 12,
wherein said segment driver has an incorporated memory writing and reading said display data to be displayed on a liquid crystal panel, and
wherein said display data conversion circuit converts said display data outputted from said incorporated memory to said first display data and second display data, respectively, by a positive-negative switch signal.

17. The liquid crystal drive control device according to claim 12, wherein said display data is given by a microprocessing unit for generating said display data.

18. The liquid crystal drive control device according to claim 12, which is manufactured over one semiconductor substrate.

19. The liquid crystal drive method according to claim 4, wherein said display data is given by a microprocessing unit for generating said display data.

20. The liquid crystal display system according to claim 10, wherein said liquid crystal display system has a microprocessing unit for generating said display data.

21. The liquid crystal drive control device according to claim 16, wherein said display data is given by a microprocessing unit for generating said display data.
